(19) United States
(12) Patent Application Publication
(10) Pub. No.: US 2010/0026641 A1
(43) Pub. Date: Feb. 4, 2010

(54) Fixation and Ejection Mechanism of Touchpad Module and Method of Releasing Touchpad Module

(75) Inventors: Yi-Ming Chang, Taipei City (TW); Li-Che Lu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Compal Electronics, Inc., Taipei City (TW)

(21) Appl. No.: 12/371,726

(22) Filed: Feb. 16, 2009

(30) Foreign Application Priority Data
Aug. 1, 2008 (TW) 97129337

(51) Int. Cl. G06F 3/041

(52) U.S. Cl. 345/173

(57) ABSTRACT

A fixation and ejection mechanism of a touchpad module is described. The fixation and ejection mechanism of the touchpad module includes a module fixing pillar, a boss and a fastener. The module fixing pillar is disposed in proximity to a touchpad module of an electronic apparatus. The boss is preferably formed on a case of the electronic apparatus. The fastener fastens the boss to the modular fixing pillar. When the fastener is disengaged from the module fixing pillar, it can be utilized to push the touchpad module upward. A method of releasing touchpad module is also disclosed herein.

### RELATED APPLICATIONS

The present application is based on, and claims priority from, Taiwan Application Serial Number 97129337, filed Aug. 1, 2008, which is herein incorporated by reference.

### FIELD OF THE INVENTION

The present invention generally relates to a fixation and ejection mechanism of a touchpad module. More particularly, this invention relates to a fixation and ejection mechanism of a touchpad module for a notebook computer.

### BACKGROUND OF THE INVENTION

With the improvements in electronic science and technology, portable electronic devices, such as notebook computers, are becoming increasingly sophisticated. Notebooks are convenient, portable, lightweight devices capable of processing a large number of digital data and are popular to the general public.

Since notebook computers are portable and powerful computation devices, notebook computers have become a necessity for most businessmen. In addition, for conveniently operating the notebook computer, some notebook computers are equipped with a touchpad instead of a mouse. A user's finger can slide on the touchpad to control the position of the cursor on the monitor.

Because the touchpad is a position input device, the cursor on the monitor can be moved according to the movement of user's finger on the touchpad. Therefore, the touchpad has a smooth surface to allow the user's finger smoothly sliding thereon. Furthermore, the touchpad is a thin device compared with the notebook computer and disposed on the top cover of the notebook computer base. Accordingly, some electronic components, e.g. a memory module or a display card, can be disposed below the touchpad in the notebook computer base to adequately utilize the space under the touchpad.

To install, remove or replace the electronic components disposed under the touchpad, users or manufacturers have to open the touchpad from the notebook computer base. However, the surface of the touchpad is very smooth, and therefore the touchpad is difficult to open from the notebook computer base without any auxiliary tools even after the screws of the touchpad are removed. Sometimes, the touchpad has to be opened from the notebook computer base after the notebook computer base is disassembled.

### SUMMARY OF THE INVENTION

One objective of the present invention is to provide a fixation and ejection mechanism for a touchpad module to conveniently fix a touchpad module on a case of an electronic apparatus and open/release the touchpad module from the case of the electronic apparatus so as to easily install, remove or replace electronic components in proximity to the touchpad module.

To achieve these and other advantages and in accordance with the objective of the present invention, as the embodiment broadly describes herein, the present invention provides a fixation and ejection mechanism of a touchpad module for an electronic apparatus having a module fixing pillar and a fastener. The module fixing pillar is preferably disposed in proximity to the touchpad module. The fastener further includes a connecting portion and a locking portion, e.g. a screwed portion, to couple to the module fixing pillar through the case of the electronic apparatus. The fastener is able to act on the module fixing pillar to release the touchpad module from the case when the fastener is disengaged from the module fixing pillar. The fixation and ejection mechanism further includes a boss formed on the case of the electronic apparatus. For example, the boss is integrally formed with the case. The fixation and ejection mechanism further includes a stopper member to retain the fastener in the case. The fixation and ejection mechanism further includes an elastic element, e.g. a spring, to make the fastener protrude from the case when the fastener is disengaged from the module fixing pillar. Furthermore, a reservoir is preferably formed above the stopper member to accommodate the locking portion of the disengaged fastener. The module fixing pillar further includes a fixing hole to couple to the locking portion of the fastener. The outer diameter of the connecting portion of the fastener is preferably smaller than the inner diameter of the stop portion.

Accordingly, the fixation and ejection mechanism according to the present application can easily fix the touchpad module on the case of the electronic apparatus and easily release the touchpad module from the electronic apparatus by utilizing the fastener. Therefore, with the convenience in opening or removing the touchpad module from the case of the electronic apparatus it is easy to replace, remove or install electronic components in proximity to the touchpad module.

Another aspect of the present invention is to provide a touchpad module releasing method. The method can effectively release a touchpad module from an electronic apparatus having a case without dissembling the case of the electronic apparatus. First, an external force is applied at where the touchpad module and the case are fastened to separate the touchpad module from the case. Subsequently, the touchpad module is removed from the case. After that, the touchpad module or electronic components in proximity to the touchpad module can be repaired or replaced.

Accordingly, the touchpad module of an electronic apparatus, e.g. a notebook computer, can be released from the electronic apparatus without dissembling the case of the electronic apparatus so that the touchpad module or electronic components in proximity to the touchpad module can be easily repaired or replaced.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A illustrates a touchpad module fixed in an electronic apparatus, such as a notebook computer, according to a preferred embodiment of a fixation and ejection mechanism of a touchpad module of the present invention.

FIG. 1B illustrates the disengagement of a fastener from a module fixing pillar of the touchpad module according to the preferred embodiment of the fixation and ejection mechanism of the present invention.

FIG. 1C illustrates the release of the touchpad module from the electronic apparatus according to the preferred embodiment of the fixation and ejection mechanism of the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

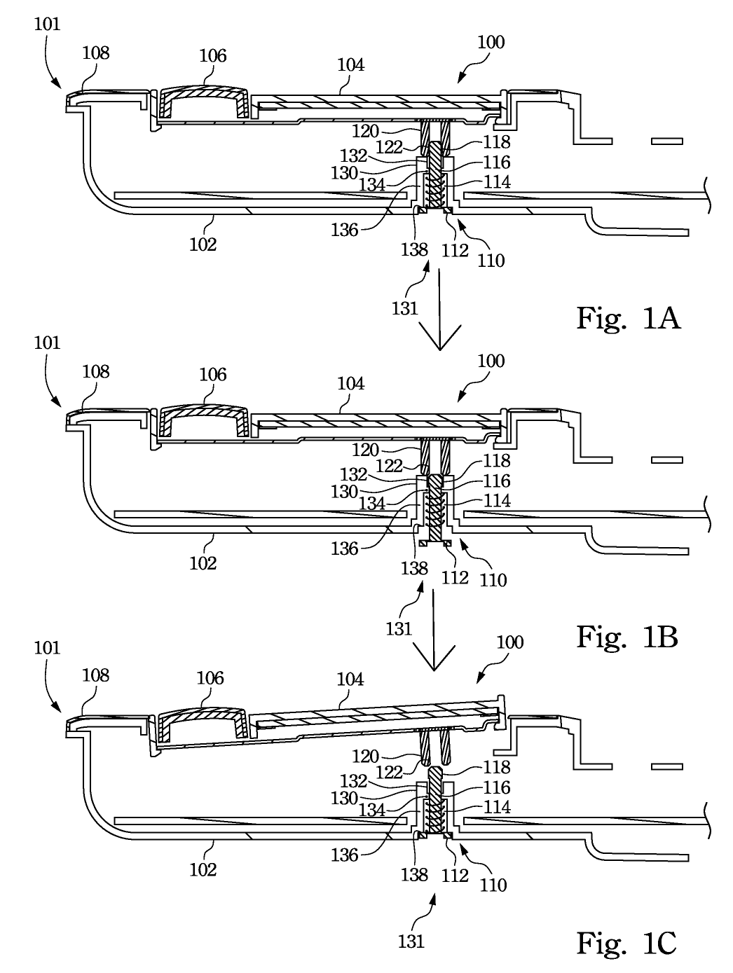

Referring to FIG. 1A, FIG. 1B and FIG. 1C, the fixation and ejection mechanism 100 of a touchpad module preferably includes a module fixing pillar 120 fixed under a touchpad module 104 and a fastener 110 coupled to the module fixing pillar 120 through an opening 131 of a case 101. The opening 131 is formed on the case 101 corresponding to a position of the module fixing pillar 120. The fixation and ejection mechanism 100 further includes a boss 130 fixed on the opening 131 of the case 101 of the electronic apparatus. In addition, the fastener 110 is coupled to the module fixing pillar 120 through the boss 130.

The module fixing pillar 120 preferably includes a fixing hole 122 formed in the module fixing pillar 120. The boss 130 preferably includes a supporting wall 136 and a stopper member 134. A reservoir 132 is formed on the stopper member 134. A fixing surface 138 is formed under the supporting wall 136. The boss 130 is preferably integrally formed with a lower cover 102. Alternatively, the boss 130 can be secured on the lower cover 102 with other coupling device without departing from the spirit and scope of the present invention. In addition, the stopper member 134 and the reservoir 132 can be integrally formed with the supporting wall 136 to form the boss 130 in one piece (as shown on the drawings), or they can be independent components assembled together. In addition, the stopper member 134 can be a stopper ring.

The fastener 110 preferably includes a head portion 112, a connecting portion 116 and a locking portion 118. The fastener 110 is coupled to the module fixing pillar 120 through the opening 131 of the case 101. The head portion 112 of the fastener 110 can be utilized to rotate the fastener 110 so that the locking portion 118 of the fastener 110 can pass through the stopper member 134 and be accommodated in the reservoir 132. The locking portion 118 passed through the stopper member 134 can hang above the stopper member 134 to be steadily accommodated in the reservoir 132. The outer diameter of the connecting portion 116 is preferably smaller than the inner diameter of the stopper member 134 so that the fastener 110 can move up and down easily.

To fix the touchpad module 104, the locking portion 118 is further moved into the fixing hole 122 of the module fixing pillar 120 for coupling. The locking portion 118 preferably has thread formed thereon to couple with the fixing hole 122, whereby the fastener 110 engages with the module fixing pillar 120, and thereby fixing the touchpad module 104 on the upper cover 108 of the case 101. The fixing hole 122 is not required to have corresponding thread formed therein for coupling with the locking portion 118, but having corresponding thread would be convenient. The fastener 110 can be a screw.

Referring to FIG. 1B, the touchpad module 104 is unfastened from the case 101. The fastener 110 is first rotated in the reversed direction to withdraw the locking portion 118 from the fixing hole 122 as well as the fastener 110 is disengaged from the fixing pillar 120 of the touchpad module 104. The disengaged fastener 110 can hang on the stopper member 134 and be accommodated in the reservoir 132. The fastener 110 preferably includes an elastic element 114, e.g. a spring, around the connecting portion 116 of the fastener 110 and between the stopper member 134 and the head portion 112. When the fastener 110 is disengaged from the module fixing pillar 120, the elastic element 114 provides an elastic force to push the fastener 110 downwardly and protrude from the lower cover 102. When subjected to an external force, the disengaged fastener 110 can slide between the opening 131 and the module fixing pillar, come in contact with the module fixing pillar 120, and push the module fixing pillar 120 to raise the touchpad module 104 from the case 101.

Referring to FIG. 1C, the touchpad module 104 is released from the case 101. To raise the touchpad module 104, the user can simply disengage the fastener 110 from the module fixing pillar 120 to allow the fastener 110 to protrude from the lower cover 102 and then press the electronic apparatus on the table so that the fastener 110 can push the module fixing pillar 120 to raise the touchpad module 104. Alternatively, the user can directly push the fastener 110 upwards after the fastener 110 is disengaged from the module fixing pillar 120 so as to push the module fixing pillar 120 and raise the touchpad module 104. That is to say, a user can apply an external force on the fastener 110 of the touchpad module 104 and the case 101 to separate and release the touchpad module 104 from the case 101.

Therefore, the fixation and ejection mechanism of the touchpad module according to the present application can easily fix the touchpad module on the case of the electronic apparatus. In addition, the fixation and ejection mechanism can easily open or remove the touchpad module from the case of the electronic apparatus to easily replace, remove or install electronic components in proximity to the touchpad module.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A fixation and ejection mechanism of a touchpad module for an electronic apparatus, comprising:
a case having an opening;
a touchpad module installed on the case;
a module fixing pillar disposed in proximity to the touchpad module; and
a fastener coupled to the module fixing pillar through the opening of the case to fix the touchpad module on the case, wherein the fastener can be used to act on the module fixing pillar to release the touchpad module from the case when the fastener is disengaged from the module fixing pillar.

2. The fixation and ejection mechanism of claim 1, further comprising a boss, wherein the fastener is coupled to the module fixing pillar through the boss.

3. The fixation and ejection mechanism of claim 2, wherein the boss is integrally formed with a lower cover of the case.

4. The fixation and ejection mechanism of claim 1, further comprising a stopper member for retaining the disengaged fastener in the case.

5. The fixation and ejection mechanism of claim 4, wherein the stopper member is a stopper ring.

6. The fixation and ejection mechanism of claim 4, wherein the stopper member is installed on the case.

7. The fixation and ejection mechanism of claim 4, wherein the fastener further comprises a connecting portion and a locking portion.

8. The fixation and ejection mechanism of claim 7, further comprising a reservoir formed above the stopper member to accommodate the locking portion of the disengaged fastener.

9. The fixation and ejection mechanism of claim 7, wherein the module fixing pillar further comprises a fixing hole to couple with the locking portion of the fastener.

10. The fixation and ejection mechanism of claim 7, wherein an outer diameter of the connecting portion of the fastener is smaller than an inner diameter of the stopper member.

11. The fixation and ejection mechanism of claim 1, wherein when the fastener is released from the module fixing pillar, the disengaged fastener is able to slide between the opening and the module fixing pillar and, when subjected to an external force, push the module fixing pillar so as to release the touchpad module from the case.

12. The fixation and ejection mechanism of claim 1, wherein the fastener further comprises an elastic element to make the disengaged fastener protrude from the case.

13. The fixation and ejection mechanism of claim 1, wherein the fastener comprises a screw.

14. The fixation and ejection mechanism of claim 1, wherein the opening is located at a position of the case corresponding to the module fixing pillar.

15. A touchpad module releasing method capable of releasing a touchpad module from an electronic apparatus having a case without dissembling the case of the electronic apparatus, the touchpad module fixed on the case of the electronic apparatus, the touchpad module releasing method comprising:
applying an external force at where the touchpad module and the case are fastened to separate the touchpad module from the case;
removing the touchpad module; and
repairing or replacing the touchpad module or an electronic component in proximity to the touchpad module.

16. The touchpad module releasing method of claim 15, further comprising unfastening the touchpad module from the case.

17. The touchpad module releasing method of claim 15, wherein the external force is a pressing force or a pushing force.

18. The touchpad module releasing method of claim 15, wherein the case is an upper cover of the electronic apparatus.
